(19) United States
(12) Patent Application Publication
(10) Pub. No.: US 2003/0049191 A1
(43) Pub. Date: Mar. 13, 2003

(54) Process for treating exhaust gas including sox

(76) Inventor: Martyn Vincent Twigg, Cambridge (GB)

Correspondence Address: Christopher R Lewis, Ratner & Prestia, One Westlakes Berwyn Suite 301, PO Box 980, Valley Forge, PA, 19482-0980, US

(21) Appl. No.: 10/149,505

(22) PCT Filed: Dec. 11, 2000
(86) PCT No.: PCT/GB00/04695

(51) Int. Cl. B01D 53/60; B01J 20/04

(52) U.S. Cl. 423/244.07; 502/415; 502/22; 422/168

(57) ABSTRACT

A process for treating an exhaust gas from a lean-burn internal combustion engine containing sulfur, oxides (SOx) and at least one other atmospheric pollutant selected from HC, CO, NO and soot, which gas being untreated or having undergone some chemical and/or catalytic treatment, comprises the steps of absorbing a sulfate-forming SOx component in a solid absorbent material, passing gas containing SO₂ to atmosphere and periodically replacing the absorbent material. A system for carrying out the process comprises exhaust passage and a sulfate absorber (26) comprising a substrate supporting a solid material for absorbing a sulfate-forming component from SOx in the exhaust gas, which sulfate absorber is adapted to be replaceable.

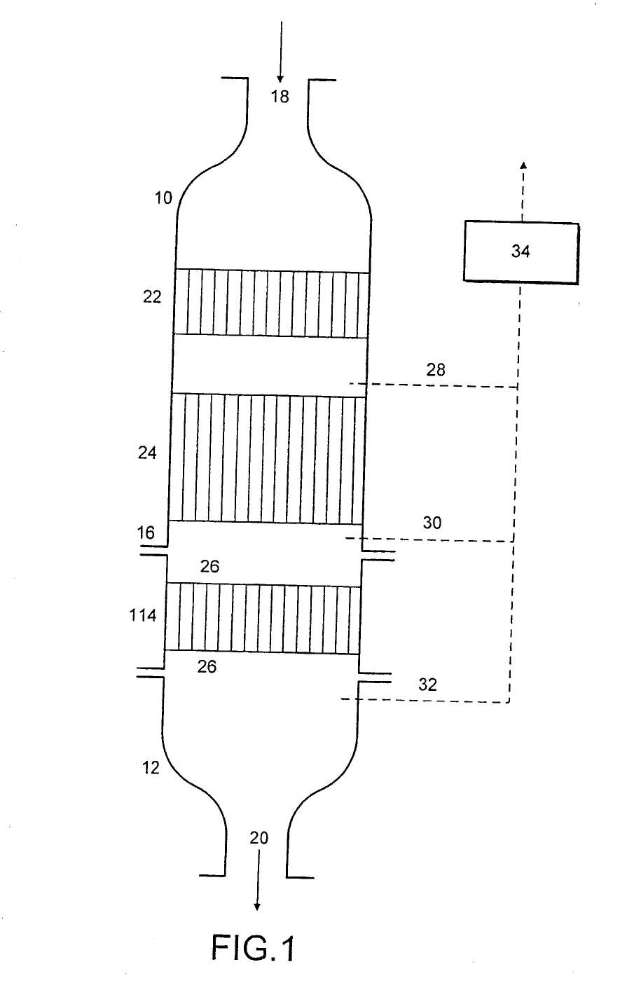

The present invention provides a process for treating an exhaust gas including sulfur oxides (SOx) and to an exhaust system for carrying out the process.

Emissions from internal combustion engines are legislated and this legislation is set to become increasingly tight in years to come. In order to control emissions to meet present requirements, vehicular exhaust systems typically include a catalytic treatment to control levels of major pollutants emitted by the engine such as unburnt hydrocarbons (HC), CO, soot and nitrogen oxides (NOx). The catalytic converter is designed to assist in converting these pollutants to less harmful species so that the amounts of the major pollutants exiting the exhaust system are within legislatively prescribed levels.

One other pollutant found in exhaust gas, SOx, is derived from sulfur in the engine fuel and/or lubricant and is more difficult to treat. SO₂ in exhaust gas can be converted to ‘sulfate’ over a catalytic converter by oxidation to SO₃ and thence via reaction with water to give sulfuric acid. Not only is sulfuric acid potentially damaging to health and the environment, but it forms a mist and is measured as particulate matter (PM) in legislatively prescribed emission test procedures. Levels of sulfur in fuel and lubricant are set to decrease to meet future emission legislation, but for the meantime the problems it causes in exhaust gas after-treatment remain. SOx can compromise the efficiency of components for controlling exhaust emissions such as Johnson Matthey's Continuously Regenerating Trap CRT™ technology.

The process used in the CRT™ is described in EP-A-0341382 and U.S. Pat. No. 4,902,487 (both incorporated herein by reference). It comprises treating exhaust gas including NO and soot from an internal combustion engine, particularly from a diesel engine, by passing it unfiltered over an oxidation catalyst to convert NO to NO₂, collecting the soot on a filter and combusting the collected soot by reaction with the NO₂.

A number of ways of combating the SOx have been proposed. EP 0582917A1 describes an exhaust system including a NOx trap and an upstream SOx trap. A NOx trap generally includes a component for oxidising NO to NO₂ during lean running conditions e.g. platinum. The NO₂ is subsequently absorbed by a component such as BaO in the NOx trap composition, and is stored as the nitrate. Subsequently, the engine is controlled to run rich, and the stored NO₂ is released (thereby regenerating the NOx trap) and is reduced to N₂, typically over a catalytic reduction component such as rhodium. However, the component for oxidising NO also oxidises SO₂ to SO₃ and this is absorbed by the BaO and stored as the sulfate. The sulfate is more stable than the nitrate, even under rich running conditions, and so the NOx storage capacity of the NOx trap dwindles as the number of storage sites are taken up by the sulfate. To combat this, EP 0582917A1 includes a SOx trap upstream of the NOx trap of similar formulation to the NOx trap. At column 5, line 2 it states “the whole SOx discharged from the engine is absorbed in the SOx absorbent and the SOx absorbed in the SOx absorbent is not released even if the air-fuel mixture fed into the combustion chamber is made rich.” To meet this problem Johnson Matthey, among others, have proposed a method of intermittently regenerating a SOx trap in situ (see EP 814242A).

We have now found that the problem of sulfate formation leading to increased detected particulate matter can be reduced or overcome by absorbing only the sulfate-forming component of the SOx from the exhaust gas and passing gas containing SO₂ to the atmosphere.

According to a first aspect, the invention provides a process for treating an exhaust gas from a lean-burn internal combustion engine containing sulfur oxides (SOx) and at least one other atmospheric pollutant selected from HC, CO, NO and soot, which gas is untreated or has undergone some chemical and/or catalytic pre-treatment, which process comprises the steps of absorbing a sulfate-forming SOx component of the gas in a solid absorbent material which is substantially free of material catalytic for SO₂ oxidation, passing an SO₂ component of the gas to atmosphere and replacing the absorbent material when its sulfate-absorbing capacity is depleted.

According to a feature of the present invention the absorbent material can be removed from the exhaust system and replaced with fresh absorbent material at intervals. The duration of the interval may depend on, amongst other factors, the capacity of the material for absorbing the sulfate-forming SOx component, and on the level of sulfate-forming SOx component in the exhaust gas flowing in the exhaust system. The capacity remaining in a sulfate trap for absorbing sulfate-forming SOx component can be assessed using standard techniques. These include the use of sensors and/or the programming of an engine management system with pre-determined “maps” to estimate cumulative sulfate-forming SOx component formation in the exhaust system from the use of the engine since the absorbent material was last fresh.

The most convenient duration of an interval is that of the service interval, e.g. one year or 12,000 miles on a conventional family vehicle including a light-duty diesel engine. This would enable the absorbent material to be replaced at the same time as other components such as spark plugs and oil filters. Of course, the circumstances may allow that the absorbent material be replaced only at intervals which are multiples of, e.g. two or three times, the regular service interval.

‘Replacing’ means removing the absorbent from the exhaust system and inserting a fresh charge thereof. The removed absorbent, depending on its composition, can be regenerated off-engine with precautions to avoid impermissible emission of sulfate.

The gas to be treated may be raw, i.e. untreated, or may have undergone some chemical and/or catalytic treatment prior to the step of absorbing the sulfate-forming SOx component. In a preferred form of the invention such preceding treatment comprises oxidising NO to NO₂. Such a step typically oxidises also HC and CO and possibly some soot components, and may if desired be effected in stages, the first of which oxidises mainly the HC and CO and possibly soot components, and the second oxidises mainly the NO. As will be appreciated, the step of oxidising NO to NO₂ can also promote oxidation of SO₂ to SO₃. However, the catalyst can be chosen and/or the temperature controlled so as to limit SO₂ oxidation, and gas-phase oxidation of SO₂ by NO₂.

Alternatively or additionally the gas may be treated by introduction of ozone, as described in WO 99/36162 or by the action of a plasma generator, as described in WO 00/21646, since such process steps can be operated without substantial oxidation of SO₂ to SO₃.

The skilled person will be aware of a number of ways of reducing the formation of sulfate-forming SOx components in an exhaust system. One way is to keep the temperature of the exhaust gas as low as possible. This can be accomplished by using, for example, exhaust gas recirculation (EGR) to the engine inlet or positioning oxidation catalysts in cooler parts of the exhaust system e.g. underfloor, away from the exhaust manifold. However, when the skilled person sets out to design an exhaust system for a vehicle, reducing the level of oxidation of SO₂ is not the sole concern and it usually assumes secondary importance to e.g. hydrocarbon oxidation or oxidation of NO to NO₂ in the CRT™. Moreover, engines for heavy-duty diesel (HDD) vehicles run at higher temperatures than light-duty diesel (LDD) engines for passenger vehicles. Furthermore, engines in vehicles such as Transit™-style vans, which may be classed as LDD, often run much hotter than similar engines in passenger vehicles because they are designed to pull greater loads and are geared accordingly. Thus the problem of reducing or avoiding the formation of sulfate-forming SOx components in exhaust systems including exhaust treatment components including e.g. oxidation catalysts is difficult.

HDD vehicles in Europe are defined as vehicles of greater than 3.5 tonnes gross weight. In the majority of US States, HDD is defined as vehicles of greater than 8500 lbs (3856 kg) gross weight. In California, we believe that vehicles of gross weight greater than 6000 lbs (2722 kg) are categorised as non-light duty, with a band for medium-duty diesel from 6000-14000 lbs (2722-6350 kg) gross weight, with heavy-duty diesel above 14000 lbs (6350 kg). For the purposes of this description we intend that the definition “heavy-duty diesel” embrace both medium-duty and heavy-duty diesel as defined under Californian law.

In the sulfate absorbing step, SO₃ may be absorbed as such or as a product of further reaction, in particular with water vapour normally present, especially in exhaust gas from an engine consuming hydrocarbon fuel.

In a particular form of the invention the gas is treated, e.g. by filtration to remove soot before sulfate removal but after catalytic NO oxidation or ozone introduction or plasma action. Such a process typically uses the above-mentioned CRT™ technology. If the filter is catalysed, with or without a preceding separate NO oxidation, catalytic oxidation of SO₂ on the filter can be limited by choice of catalytic material and/or by control of temperature.

In a second aspect, the invention provides an exhaust system for a lean-burn internal combustion engine, which system comprising a sulfate absorber optionally further comprising chemical or catalytic pretreatment means, which sulfate absorber comprising a substrate supporting a solid material for absorbing a sulfate-forming SOx component from an exhaust gas which solid material is substantially free of material for catalysing SO₂ oxidation, which sulfate absorber is adapted to be replaceable when its sulfate absorbing capacity is depleted.

In a third aspect the invention provides a lean-burn internal combustion engine, preferably a diesel engine, most preferably a heavy-duty diesel engine in combination with an exhaust system according to the invention. To lengthen the life of the sulfate absorber between replacements, and/or to limit its volume and pressure-drop, the engine is preferably run on fuel of low sulfur content, for example less than 50, especially less than 10 ppm w/w as sulfur.

In a fourth aspect, the invention provides a vehicle including an engine according to the invention.

In a fifth aspect, the invention provides a sulfate absorber according to the invention wherein the solid absorbent comprises from 2 to 5 g per cubic inch of a mixed washcoat containing barium oxide (10-20% w/w), ceria (15-40% w/w) and alumina (balance).

In a sixth aspect, the invention provides a sulfate absorber according to the invention wherein the solid absorbent comprises from 0.5 to 4.0 g per cubic inch of a 2:1 to 1:2 mixture of a high-surface area alumina (50-150 m²g⁻¹) and zeolite beta, the washcoat including calcium oxide at from of 0.1 to 0.5 g per cubic inch (as calcium metal).

The absorbent is suitably supported on the surface of a ceramic or metal honeycomb. A conventional washcoat layer may be used. To increase the loading of absorbent and/or limit coating thickness, the absorbent may be applied to an uncoated honeycomb. It may be in a vessel adapted to be interchangeably joined to an exhaust treatment reactor or between upstream and downstream sections thereof; or in a cassette adapted to be positioned in such a central section or in the open end of such an upstream or downstream section. The reactor or reactor section may be constructed to removeably accommodate such a cassette or the coated honeycomb.

In a seventh aspect the invention provides a process for regenerating a sulfate-loaded absorber according to the invention comprising separating the absorber from the exhaust system, removing, preferably by washing, spent absorbent from the surfaces of the substrate and applying fresh absorbent thereto. Such washing may employ additives such as detergents and measures such as pH adjustment. Thus the expensive honeycomb can be re-used. The washings may be treated to recover spent absorbent components if this is economic.

The honeycomb substrate for the absorbers, catalysts and filter for use in the process or system according to the invention may be made structurally of ceramic, for example cordierite, alumina, mullite, silicon carbide, zirconia or sodium/zirconia/phosphate, or metal, for example thermally resistant alloy such as Fecraloy™. Typically the honeycomb has at least 50 cells per square inch (cpsi), possibly more, e.g. up to 800 cpsi if ceramic, or still more e.g. up to 1200 cpsi if metal. Generally the range 100-900 cpsi is preferred.

For catalysts and absorbers the honeycomb walls are substantially gas-impermeable and preferably carry a surface area-enlarging washcoat suitably comprising one or more of alumina, ceria, zirconia, silicon carbide or other, generally oxidic, material. In and/or on the washcoat, in one or more layers, is the absorbent and/or catalytic material. The gas-impermeability of the walls may be inherent or may be provided by using filter-grade honeycomb and obstructing its pores by wash-coating.

The structural material of the filter honeycomb may be selected from the same materials as used for the catalyst honeycomb. When the filter honeycomb is ceramic, it may be the product of shaping (e.g. by extrusion) a composition containing sufficient fugitive material to leave on removal e.g. by calcination, the required pores. Honeycomb, whether ceramic or metal, may be the product of moulding and sintering a powder, possibly via foam. Other filters may comprise metal mesh or wire. Filter-grade honeycomb suitably has a mean pore diameter in the range 0.1×10⁻³ to 20×10⁻³ inch (0.25 to 50 μm). The filter may carry a coating such a the above-mentioned washcoat and/or a catalyst such as one or more PGMs such as Pt+MgO, or La/Cs/V₂O_{5,}, provided its fluid permeability is not seriously impaired and provided such catalyst is formulated to avoid or limit SO₂ oxidation at accessible temperatures.

In the oxidation catalyst and any final catalyst the active material comprises for example a platinum group metal (PGM), especially Pt and/or Pd, optionally with other PGMs, e.g. Rh, and other catalytic or promoting components. The exact compositions and structure of these catalysts may be varied according to the requirements of the situation. A low temperature light-off formulation is generally preferred for the oxidation catalyst.

The oxidation catalyst(s) and filter may be provided on a single brick of filter-grade honeycomb, the pores in the catalyst region being obstructed by washcoat.

In the absorber for sulfate, the chemically active coating may comprise for example:

(a) compounds of alkali metals, alkaline earth metals, rare earth metals and transition metals, capable of forming sulfates of adequate stability; and

(b) adsorptive materials such as zeolites, carbons and high-area oxides.

Compounds (a) may be present (before absorption) as composite oxides, e.g. of alkaline earth metal and copper such as Ba—Cu—O or MnO₂—BaCuO₂ , possibly with added Ce oxide, or Y—Ba—Cu—O and Y—Sr—Co—O, or rare earth mixed oxides such as CeO₂/ZrO₂. Whereas absorber materials are specified in terms of oxides, it will be appreciated that during operation of the process they may be present as for example hydroxides, carbonates and nitrates appropriate to the gas contacting them.

Whichever compounds are used, the absorbent is preferably free of material catalytic for SO₂ oxidation. The absorbent may be provided in one unit or a succession of separate units.

The sulfate absorber may contain materials selected on economic grounds, since it is not regenerated in situ but has a life limited by its chemical absorption capacity.

A suitable SOx absorbent comprises at least one alkaline earth oxide, especially calcium oxide, possibly with others such as magnesium oxide e.g. dolomite, or formulations containing SrO or BaO. Such oxide may adhere direct to the honeycomb or with the aid of a surface-increasing washcoat. Suitably it is applied as carbonate, as a mechanically or chemically formed dispersion or by precipitation on to the honeycomb surface.

Among preferred sulfate absorbers there may be mentioned:

(a) honeycomb carrying 2 to 5 g per cubic inch of a mixed washcoat containing barium oxide (e.g. 10-20% w/w), ceria (15-40% w/w) and alumina (balance); and

(b) honeycomb carrying a washcoat layer of 0.5 to 4.0 g per cubic inch of a 2:1 to 1:2 mixture of high-surface alumina (50-150 m²g⁻¹) and zeolite beta, the washcoat carrying calcium oxide at an over-all loading (calculated as calcium metal) of 0.1 to 0.5 g per cubic inch.

Methods of preparing the sulfate absorber include assembling a washcoat suspension containing sulfate-reactive material, high-surface oxide such as alumina and optionally auxiliary materials such as rare earth oxide, and applying it to the honeycomb. In another method, a washcoat suspension containing high-surface oxide such as alumina and/or zeolite is applied to honeycomb and then impregnated with sulfate-reactive material, possibly in solution. In any method of preparing sulfate absorber, one or more components may be applied as a precursor compound convertible e.g. by heating or contacting with hot exhaust gas, to the required active or high-surface material. Examples of such precursors are nitrates, acetates and bicarbonates of alkaline earth metals and hydrated aluminas.

The invention is illustrated by the accompanying drawing, which shows in sectional elevation an exhaust gas treatment reactor containing catalysts and absorbers corresponding to the steps of the process of the invention. In the drawing material items are shown in full lines and the flow of information and control power is shown in dotted lines.

In the drawing the reactor comprises a can having inlet section 10, outlet section 12 and central section 14, the three sections being held together by flanges 16. Inlet 18 is to be connected to the exhaust pipe of an engine cylinder block. Nearest inlet 18 is ceramic honeycomb-supported oxidation catalyst 22. Next follows filter 24, which is made of filter-grade ceramic honeycomb. The next stage, 26, which is mounted in the separable central section 14 of the reactor, is a ceramic honeycomb-supported alkaline earth carbonate sulfate absorber. From section 12 treated gas passes via outlet 20 to atmosphere.

The reactor includes sensors 28, 30, 32 for temperature and gas composition. Sensors 28 and 30 also measure pressure-drop across filter 24. Values sensed by the sensors are reported to and processed by computer 42, to provide control signals, for example, notifying the need to replace sulfate absorber 26. For convenience in replacement, section 14 contains no control gear.

In the operation of the process, exhaust gas first encounters oxidation catalyst 22, which may be in two or more serially connected parts if the oxidation of HC and NO are to be separately optimised. Oxidation of SO₂ to SO₃ by O₂ and NO₂ is limited by choice of catalyst and control of temperature. The gas, containing soot and NO₂, enters filter 24, where the collected soot is combusted by the NO₂. It now enters reactor central section 14 and is stripped of its sulfate-forming content in absorber 26. It may then be discharged to atmosphere or further treated (not shown).

When a pre-set period has elapsed or sensor 32 reports the presence of sulfate, the engine is stopped and the exhaust system is allowed to cool. Then flanges 16 are opened, reactor central section 14 is removed and replaced and the flanges 16 re-closed. Sulfate absorber 26 is extracted from central section and sent for regeneration or material recovery. By way of example, a vehicle using diesel fuel of 10 ppm sulfur content at the rate of 20 mpg would at most accumulate 80 g of sulfate (as SO₃) in 20000 miles (assuming an air:fuel ratio of approximately 30:1). Or diesel fuel of 50 ppm would yield approximately 1.6 ppm SO₂ in the exhaust gas. Assuming 20% SO₂ oxidation and that the resulting sulfate-forming SOx component is absorbed, the replaceable trap would also accumulate approximately 80 g of sulfate in 20000 miles. Thus a reasonably-sized sulfate absorber for a medium-heavy vehicle would last the service interval.

In order that the invention may be fully understood, the following Examples are provided by way of illustration only.

### EXAMPLE 1

A 12 litre 318 kW turbo-charged, after-cooled direct-injection diesel engine was operated with a series of fuels derived from Swedish class I diesel fuel by addition of thiophene to provide three samples each of: no thiophene added fuel and 10, 20, 30 and 40 ppm sulfur w/w fuels.

The engine was run on the standard European Steady State (ESC) test cycle and the particulate matter (PM) in the exhaust gas measured in the prescribed way, after the gas had passed through an oxidation catalyst (22) containing platinum on alumina at a platinum loading of 75 g ft⁻³ (2.65 g litre⁻¹) deposited on a ceramic substrate 10.5 inch diameter×6 inch long (267×152 mm) containing 400 cells per square inch (65 cm⁻²) and a cordierite wall flow particulate filter (24) 10.5 inch diameter×12 inch long (267×304 mm) containing 100 cells per square inch (16 cells cm⁻²).

The results of the PM measurements were:

| | | | | | |
|---|---|---|---|---|---|
| Fuel S ppm w/w | 3 | 10 | 20 | 30 | 40 |
| Outlet PM mg/kWh | 8 | 10 | 16 | 20 | 25 |

It is evident that the outlet PM is a linear function of fuel sulfur content, together with a constant contribution attributable principally to sulfur present in the lubrication oil that is combusted in the engine.

These experiments show sulfate derived from combustion of sulfur compounds in an internal combustion engine result in an apparent contribution to PM when measured in the standard way.

Analysis of the PM showed it consisted almost entirely of sulfate together with small amounts of nitrate.

### EXAMPLE 2

In order to demonstrate the principal that a solid absorbent material according to the invention can absorb sulfate-forming SOx components, such as SO₃, from a gas stream whilst allowing SO₂ to pass, a laboratory test was carried out on a conventional SCAT rig. The sulfate ‘trap’ was prepared by application of a washcoat of calcium oxide to a loading density of approximately 2.5 g in⁻³ (41.0 g cm⁻³) a ceramic honeycomb substrate of 400 cells in⁻² (65 cells cm⁻² and wall thickness 6×10⁻³ inch (0.015 cm). Cores 1.5 inches (3.8 cm) long were obtained for testing. SO₃ was generated in the gas stream by oxidising the SO₂ using a platinum on alumina catalyst upstream of the core.

Three test cores were tested for their steady state performance at a temperature of 300° C. for ten minutes. The synthetic gas mixture entering the oxidation catalyst had the composition CO₂ 200 ppm, NO₂ 200 ppm, SO₂ 20 ppm (approximating to about 500 ppm sulfur content diesel fuel), hydrocarbon (C₃) 100 ppm, O₂ 12%, H₂O 4.5%, CO₂ 4.5%, N₂ balance at a space velocity of 40000 hr⁻¹ for the whole system. Gas exiting the core was analysed using mass spectrometry in real time.

12 ppm SO₂ was detected in the gas composition exiting the cores. This result indicates that some SO₂ is oxidised by the oxidation catalyst, but that this is absorbed by the sulfate trap. The presence of SO₂ in the gas composition exiting the core show the ability of the sulfate trap to ‘slip’ SO₂.

### EXAMPLE 3

A standard oxidation catalyst comprising platinum on alumina coated on a cordierite monolithic substrate (4.66″ (11.84 cm) diameter, 3″ (7.62 cm) long) having 400 cells/inch² (65 cells cm⁻²) and wall thickness of 8 1/1000 inch (0.02 cm) with a platinum loading of 1.4 g/litre and a washcoat loading of 150 g/litre, was fitted in an underfloor position on a 1999 model year vehicle with a 1.7 litre naturally aspirated direct injection diesel engine compliant to European Stage 3 emissions regulations. The vehicle was run over the European Stage 3 drive cycle using diesel fuel containing 350 ppm sulfur with typical exhaust gas temperatures experienced in a light duty Transit™-style van. The measured particulate emissions were 0.146 g/km.

The catalyst was then removed and replaced by a bare monolithic substrate having the same dimensions as the previous catalyst, and the vehicle was run under identical conditions over the European Stage 3 test cycle. The particulate emissions were 0.077 g/km showing at least 0.069 g/km of sulfate was produced over the catalyst (the catalyst also removed some hydrocarbon from the particulate emission). A catalyst identical to that used in the first test was prepared with addition of MgO corresponding to 18 g/litre was then fitted to the vehicle, and run over the European stage 3 test cycle, as before. The particulate emissions were 0.056 g/km showing the sulfate absorber removed 0.090 g/km of sulfate.

### EXAMPLE 4

A standard oxidation catalyst comprising platinum on alumina coated on a cordierite monolithic substrate (4.66″ (11.84 cm) diameter, 3″ (7.62 cm) long) having 400 cells/inch² inch² (65 cells cm⁻²) and wall thickness of 8 1/1000 inch (0.02 cm) with a platinum loading of 2.8 g/litre and a washcoat loading of 150 g/litre, was fitted in an underfloor position on a 1999 model year vehicle with a 1.7 litre naturally aspirated direct injection diesel engine compliant to European Stage 3 emissions regulations. A bare monolithic substrate having the same dimensions as the catalyst was placed behind the catalyst. The vehicle was run over the European Stage 3 drive cycle using diesel fuel containing 350 ppm sulfur with typical exhaust gas temperatures experienced in a light duty Transit™-style van. The measured particulate emissions were 0.120 g/km.

The catalyst was then removed and replaced by a bare monolithic substrate having the same dimensions as the previous catalyst, and the vehicle was run under identical conditions over the European Stage 3 test cycle. The particulate emissions were 0.077 g/km showing at least 0.043 g/km of sulfate was produced over the catalyst (the catalyst also removed some hydrocarbon from the particulate emission). A substrate coated with alumina containing CaO corresponding to 24.5 g/litre was placed behind the platinum on alumina catalyst from the first test, and run over the European Stage 3 test cycle, as before. The particulate emissions were 0.046 g/km showing the sulfate absorber removed 0.074 g/km of sulfate

1. A process for treating an exhaust gas from a lean-burn internal combustion engine containing sulfur oxides (SOx) and at least one other atmospheric pollutant selected from HC, CO, NO and soot, which gas is untreated or has undergone some chemical and/or catalytic pre-treatment, which process comprises the steps of absorbing a sulfate-forming SOx component of the gas in a solid absorbent material which is substantially free of material catalytic for SO₂ oxidation, passing an SO₂ component of the gas to atmosphere and replacing the absorbent material when its sulfate-absorbing capacity is depleted.

2. A process according to claim 1, wherein the step of pre-treating the gas includes the step of oxidising NO to NO₂.

3. A process according to claim 2, wherein the NO is oxidised using ozone and/or a plasma.

4. A process according to claim 2 or 3, including the step of treating the gas to remove soot before removing the sulfate-forming component.

5. A process according to claim 2 or 3, including the step of treating the gas to remove soot after removing the sulfate-forming component.

6. A process according to claim 4 or 5, wherein the soot treatment step includes filtering soot from the gas.

7. A process according to claim 6, wherein soot trapped on the filter is combusted in gas containing NO₂ at a temperature below 400° C.

8. A process according to any preceding claim, wherein the lean-burn combustion engine is run on fuel of sulfur content less than 50 ppm w/w as sulfur and the exhaust gas is a product therefrom.

9. An exhaust system for a lean-burn internal combustion engine, which system comprising a sulfate absorber optionally further comprising chemical or catalytic pre-treatment means, which sulfate absorber comprising a substrate supporting a solid material for absorbing a sulfate-forming SOx component from an exhaust gas which solid material is substantially free of material for catalysing SO₂ oxidation, which sulfate absorber is adapted to be replaceable when its sulfate absorbing capacity is depleted.

10. A system according to claim 9, further comprising means for generating and/or introducing ozone and/or a plasma for oxidising NO to NO₂ in the exhaust passage upstream of the sulfate absorber.

11. A system according to claim 10, wherein the ozone and/or plasma generating means comprises a source of UV light and/or a corona discharge device.

12. A system according to claim 9, 10 or 11, further comprising an oxidation catalyst for oxidising NO to NO₂, which oxidation catalyst is disposed in the exhaust passage upstream of the sulfate absorber.

13. A system according to claim 10, 11 or 12, further comprising a soot filter disposed between the means for oxidising NO to NO₂ and the sulfate absorber, whereby soot trapped on the filter is capable of combustion in gas containing the NO₂ at a temperature below 400° C.

14. A system according to claim 10, 11 or 12, further comprising a soot filter disposed downstream of the means for oxidising NO to NO₂ and the sulfate absorber, whereby soot trapped on the filter is capable of combustion in gas containing the NO₂ at a temperature below 400° C.

15. A system according to claim 13 or 14, wherein the filter is catalysed.

16. A system according to any of claims 9 to 15, wherein the sulfate absorber comprises (a) at least one compound of alkali metals, alkaline earth metals, rare earth metals or transition metals; and/or (b) at least one zeolite, carbon or high-surface area oxide or a mixture of any two or more thereof.

17. A system according to claim 16, wherein the sulfate absorber includes a mixed metal oxide or a composite oxide including at least one metal from (a).

18. A system according to claim 17, wherein the composite oxide is of an alkaline earth metal and copper, preferably Ba—Cu—O, MnO₂—BaCuO₂ optionally further including CeO₂, Y—Ba—Cu—O or Y—Sr—Co—O.

19. A system according to claim 17, wherein the mixed metal oxide is CeO₂/ZrO₂.

20. A system according to claim 16, wherein the alkaline earth metal compound is CaO, MgO, SrO or BaO.

21. A system according to any of claims 9 to 20, wherein the substrate is ceramic.

22. A lean-burn internal combustion engine, preferably a diesel engine, in combination with the exhaust system according to any of claims 9 to 21.

23. An engine according to claim 22, wherein it is a heavy-duty diesel engine.

24. An engine according to claim 22 or 23 run on fuel of sulfur content less than 50 ppm w/w as sulfur.

25. A vehicle including an engine according to claim 22, 23 or 24.

26. A sulfate absorber according to any of claims 9 to 21, wherein the solid absorbent comprises from 2 to 5 g per cubic inch of a mixed washcoat containing barium oxide (10-20% w/w), ceria (15-40% w/w) and alumina (balance).

27. A sulfate absorber according to any of claims 9 to 21, wherein the solid absorbent comprises from 0.5 to 4.0 g per cubic inch of a 2:1 to 1:2 mixture of a high-surface area alumina (50-150 m² g⁻¹) and zeolite beta, the washcoat including calcium oxide at from of 0.1 to 0.5 g per cubic inch (as calcium metal).

28. A sulfate absorber according to claim 26 or 27 in a can or shell adapted to be releasably inserted in an exhaust system.

29. A process for regenerating a sulfate-loaded sulfate absorber according to any of claims 9 to 27, comprising separating the absorber from the exhaust system, removing, preferably by washing, spent absorbent from the surfaces of the substrate and applying fresh absorbent thereto.
